(19) United States
(12) Patent Application Publication
(10) Pub. No.: US 2026/0219240 A1
(43) Pub. Date: Jul. 30, 2026

(54) RIG SITE CHROMATOGRAPHIC COLUMN RECONDITIONING

(71) Applicant: SCHLUMBERGER TECHNOLOGY CORPORATION, Sugar Land, TX (US)

(72) Inventors: Jerome BREVIERE, Clamart (FR); Elena Borisova, Clamart (FR); Jean-Pierre BAILLY, Clamart (FR); Coralie VINOLO, Clamart (FR)

(21) Appl. No.: 19/140,383

(22) PCT Filed: Mar. 28, 2024
(86) PCT No.: PCT/US2024/021978

§ 371 Date: Jun. 18, 2025

(30) Foreign Application Priority Data
Mar. 30, 2023 (EP) 23305456.8

(51) Int. Cl. G01N 30/30; G01N 30/02; G01N 30/46

(52) U.S. Cl. CPC G01N 30/30; G01N 30/465; G01N 2030/025

(57) ABSTRACT

A method for reconditioning a gas chromatography apparatus at a rig site includes providing a gas chromatography (GC) apparatus including at least a trapping column, a main column, and a detector. The main column is configured to separate at least methane, ethane, propane, butane, and pentane compounds in a gas stream. The trapping column is configured to remove interfering alkene or alcohol compounds from the gas stream. A plurality of GC measurements is made at the rig site by flowing the gas stream in a forward direction through the trapping column and the main column to the detector. A reconditioning gas is flowed in a reverse direction through the trapping column on the rig site after completing the plurality of GC measurements while heating the trapping column to a temperature of at least 120 degrees C. to recondition the trapping column.

### CROSS REFERENCE TO RELATED APPLICATIONS

This application claims the benefit of EPO Application No. EP23305456.8, entitled “RIG SITE CHROMATOGRAPHIC COLUMN RECONDITIONING” filed Mar. 30, 2023, the disclosure of which is hereby incorporated herein by reference.

### BACKGROUND

When drilling a subterranean wellbore, circulating drilling fluid commonly carries formation fluids and dissolved formation gasses to the surface. Such gasses may be liberated by the drill bit as it cuts the formation and may include various alkane gasses such as methane (C1), ethane (C2), propane (C3), butane (C4), pentane (C5), and the like, as well as alkenes and alcohols. The liberated gases are commonly evaluated at the surface while drilling. Such measurements may provide valuable information to a mud logger and may provide information about the maturity and nature of hydrocarbons in the reservoir, compartmentalization of intervals in the reservoir being drilled, and oil quality, as well as information regarding production zones, lithology changes, history of reservoir accumulation, or seal effectiveness.

Gas chromatography is often used to separate and analyze the liberated gases. In some operations, continuous measurements are made while drilling with the intent being to quantify the light hydrocarbon compounds (e.g., alkane gases from C1 to C5 or from C1 to C8 for an enriched and more complete analysis) while tolerating or neutralizing non-hydrocarbon compounds such as alcohols that can be generated by the degradation of the drilling fluid at high temperatures and pressure in the borehole. Such measurements can be difficult, particularly in oil based drilling fluids including synthetic oils. These drilling fluids commonly include or generate interfering compounds having an elution time between the elution times of C1 and C5 alkanes and can result in an over estimation of alkane gases (particularly of the C4 and C5 gases).

Commonly assigned U.S. Pat. No. 8,616,051 discloses the deployment of a polar column in or upstream of the gas chromatography column to trap the interfering compounds. While the use of such a polar column has been found to be commercially viable, the column becomes saturated with use (the saturation time depending on the quantity and nature of the interfering compounds in the gas stream). Moreover, the trapped compounds are generally too heavy to be removed via conventional backflushing of the column. In order to change the polar column, the gas chromatography instrument, including the polar column, is sent off-site for maintenance. The time and expense required to remove the gas chromatography instrument and maintain redundant equipment can be prohibitive. There is a need for gas chromatography instrument configuration and a method that provides for timely, on-site regeneration (reconditioning) of the polar column.

### BRIEF DESCRIPTION OF THE DRAWINGS

For a more complete understanding of the disclosed subject matter, and advantages thereof, reference is now made to the following descriptions taken in conjunction with the accompanying drawings, in which:

FIG. 1 depicts an example drilling rig including a disclosed gas chromatography apparatus for measuring a composition of formation gas.

FIG. 2 depicts an example gas chromatography apparatus including a precut column and a main column.

FIG. 3 depicts an example column assembly including a trapping column, a precut column, and a main column coupled with a multiport valve.

FIG. 4 depicts a block diagram of an example GC apparatus including the column assembly shown on FIG. 3.

FIG. 5 depicts a schematic of the GC apparatus shown on FIG. 4.

FIGS. 6A and 6B (FIG. 6) depict example flow diagrams for the gas chromatography apparatus shown in FIGS. 4 and 5 in which the multiport valve is in a first position in FIG. 5A and a second position in FIG. 5B.

FIG. 7 depicts a flow chart of a method for making gas chromatography measurements.

FIG. 8 depicts a flow chart of a method for reconditioning the trapping column in a gas chromatography apparatus.

### DETAILED DESCRIPTION

A method for reconditioning a gas chromatography apparatus at a rig site is disclosed. The method includes providing a gas chromatography (GC) apparatus including at least a trapping column, a main column, and a detector. The main column is configured to separate at least methane, ethane, propane, butane, and pentane compounds in a gas stream and the trapping column is configured to remove interfering alkene or alcohol compounds from the gas stream. A plurality of GC measurements are made at the rig site by flowing the gas stream in a forward direction through the trapping column and the main column to the detector. A reconditioning gas is flowed in a reverse direction through the trapping column on the rig site after completing the plurality of GC measurements. The trapping column is heated to a temperature of at least 120 degrees C. while flowing the reconditioning gas in the reverse direction to recondition the trapping column.

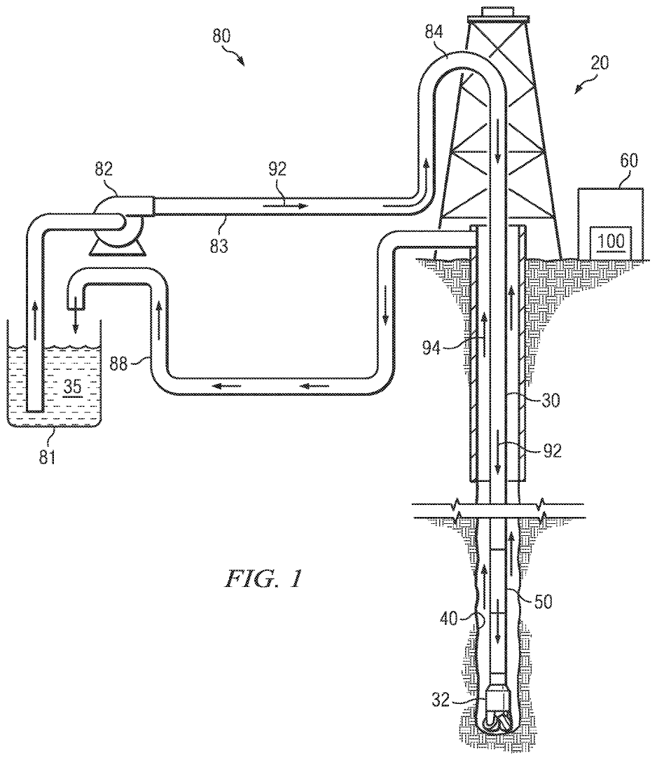

FIG. 1 depicts an example drilling rig 20 including a gas chromatography apparatus 100 for evaluating formation gas composition. The drilling rig 10 may be positioned over a subterranean formation (not shown). The rig may include, for example, a derrick and a hoisting apparatus (also not shown) for raising and lowering a drill string 30, which, as shown, extends into wellbore 40 and includes, for example, a drill bit 32 and one or more downhole measurement tools 50 (e.g., a logging while drilling tool or a measurement while drilling tool). Suitable drilling systems, for example, including drilling, steering, logging, and other downhole tools are well known in the art. Drilling rig 20 further includes a surface system 80 for controlling the flow of drilling fluid used on the rig (e.g., used in drilling the wellbore 40). In the example rig depicted, drilling fluid 35 is pumped downhole (as depicted at 92) via a conventional mud pump 82. The drilling fluid 35 may be pumped, for example, through a standpipe 83 and mud hose 84 in route to the drill string 30. The drilling fluid typically emerges from the drill string 30 at or near the drill bit 32 and creates an upward flow 94 of mud through the wellbore annulus (the annular space between the drill string and the wellbore wall). The drilling fluid then flows through a return conduit 88 to a mud pit 81. It will be appreciated that the terms drilling fluid and mud are used synonymously herein.

As is known to those of ordinary skill in the art, the formation gas may be released into the wellbore 40 via the drilling process (e.g., crushing the formation rock by the mechanical action of the drill bit) and may also migrate into the wellbore 40, for example, via fractures in the formation rock. Once in the wellbore, the formation gas may be transported to the surface via the drilling fluid (in the upwardly flowing fluid 94). The formation gas may be in solution in the drilling fluid and/or in the form of bubbles and may be sampled in the surface system, for example, via one or more drilling fluid degassers (not shown) deployed, for example, in the return conduit 88 or the mud pit 91 and/or a head space gas probe (not shown) deployed, for example, in the return conduit 88. The disclosed embodiments are expressly not limited in regards to how the gas is sampled.

With further reference to FIG. 1, drilling rig 20 may further include a testing facility 60 (e.g., a laboratory trailer including one or more instruments suitable for making various measurements of drill cuttings and formation gases in the drilling fluid). In the depicted embodiment, the testing facility 60 includes a gas chromatography apparatus 100 (described in more detail below) configured to receive the formation gas and evaluate the formation gas composition. The testing facility 60 may, of course, include numerous other testing instruments known to those of ordinary skill in the industry. It will be appreciated that disclosed embodiments may make use of substantially any suitable gas chromatography (GC) apparatus including, for example, vapor-phase chromatography (VPC) and gas-liquid partition chromatography (GLPC) connected to any suitable detector such as, but not limited to a flame-ionization detector (FID), a thermal conductivity (TC) detector, a mass spectrometer, and the like.

While GC is a powerful chemical analysis technique that enables many (most) chemical species to be separated at the detector, there remains room for improvement. In many gas samples, such as those including light hydrocarbons, certain species can have partially or fully overlapping elution times. This results in overlapping peaks in the chromatogram and tends to complicate quantitative determination of the gas composition. For example, in gas samples including light hydrocarbons (e.g., C1, C2, C3, C4, and C5), various gases such as alkenes and alcohols may overlap the saturated aliphatic hydrocarbon peaks of interest. To overcome this difficulty, a GC apparatus may further include a polar chromatographic column which acts as (and is referred to herein as) a trapping column for alcohols that may interfere with the light hydrocarbons of the gas sample without affecting the retention time of the light hydrocarbons of interest.

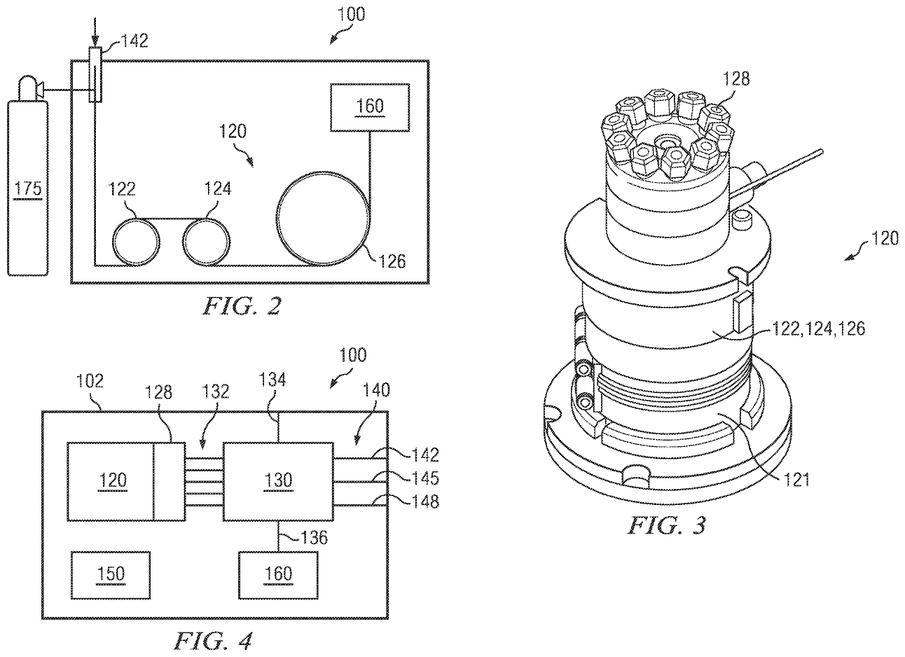

FIG. 2 depicts an example GC apparatus 100 including a gas sample injection port 142 configured to feed a gas sample into a column assembly 120 including a trapping column 122, a precut column 124 and a main GC column 126. The GC apparatus 100 further includes a carrier gas supply 175, such as a supply of compressed nitrogen, argon, helium, or air. An injected gas sample is mixed with the carrier gas and transported through the column assembly 120. The trapping column 122 is intended to remove interfering compounds in the gas stream such as alcohols. The precut column 124 may be configured to remove heavier hydrocarbon compounds having a number of carbon atoms above a threshold, such as C6, C8, or C10 and above. The main column 126 includes a stationary phase and is intended to separate the various gas compounds in the gas sample such that they arrive at the detector 160 at distinct elution times, for example, such that C1 arrives before C2, which arrives before C3, and so on. The detector may include substantially any suitable GC detector, such as an FID detector, a TC detector, or a mass spectrometer. Moreover, while example apparatus 100 includes a precut column 124, it will be appreciated that the disclosed embodiments are not limited in this regard.

FIG. 3 depicts an example column assembly 120 including a trapping column, a precut column, and a main column deployed about a mandrel 121 (the trapping column, precut column, and main column are not depicted individually in this figure). The columns are in fluid communication with a multiport (e.g., 10 port) valve 128. As described in more detail below, the multiport valve 128 enables the gas sample to be routed through the trapping column, the precut column, and the main column to the detector 160 (FIG. 2). The depicted column assembly 120 further includes one or more heating elements (also not shown) deployed on the mandrel 121. The heating elements enable the temperature of the mandrel and the columns to be controlled and/or held, for example, at any temperature up to about 200 degrees C.

FIG. 4 depicts a block diagram of an example GC apparatus 100 including the column assembly 120 shown on FIG. 3. As depicted, the column assembly is deployed in the GC housing 102. The apparatus further includes a flow manifold 130 in fluid communication with the multiport valve 128. The flow manifold 130 may include, for example, a number of controllable valves, pressure regulators, and flow regulators (not shown). In the depicted embodiment, the flow manifold is in fluid communication with the multiport valve 128 via a plurality of flow passageways at 132, an external vent at 134, a plurality of gas inlet ports at 140, and the GC detector 160 at 136. The inlet ports may include for example, a gas sample injection port 142, a carrier gas injection port 145, and a reverse flow injection port 148.

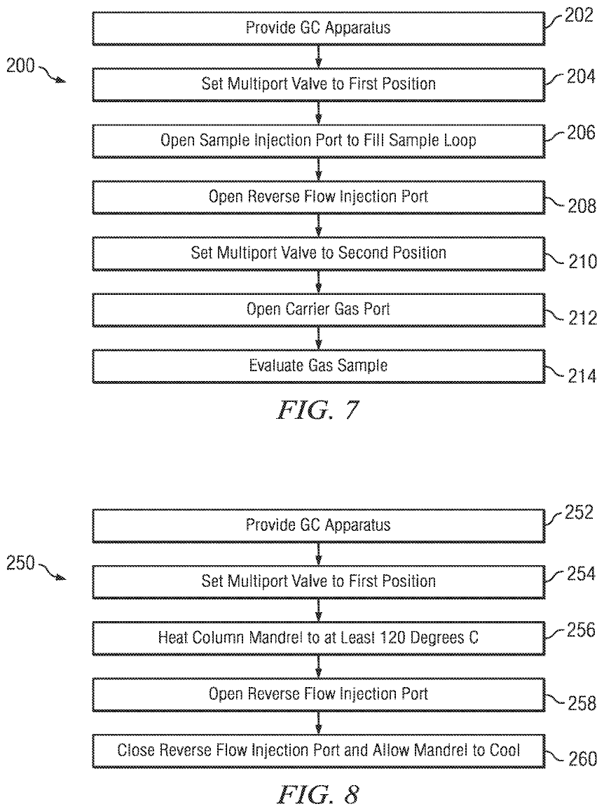

With continued reference to FIG. 4, GC apparatus 100 further includes an electronic controller 150 configured to control the detector 160, the flow manifold 130, the position of the multiport valve 128, and heating elements in the column assembly 120. In so doing, the controller may be configured to cause the GC apparatus to make GC measurements and/or to recondition the trapping column in the column assembly, for example, as described in more detail below with respect to FIGS. 7 and 8. It will, of course, be appreciated that the controller may include computer hardware and software configured to cause the GC apparatus to perform the above described functions. The hardware may include one or more processors (e.g., microprocessors) which may be connected to one or more data storage devices (e.g., hard drives or solid state memory) and user interfaces. It will be further understood that the disclosed embodiments may include processor executable instructions stored in the data storage device. The disclosed embodiments are, of course, not limited to the use of or the configuration of any particular computer hardware and/or software.

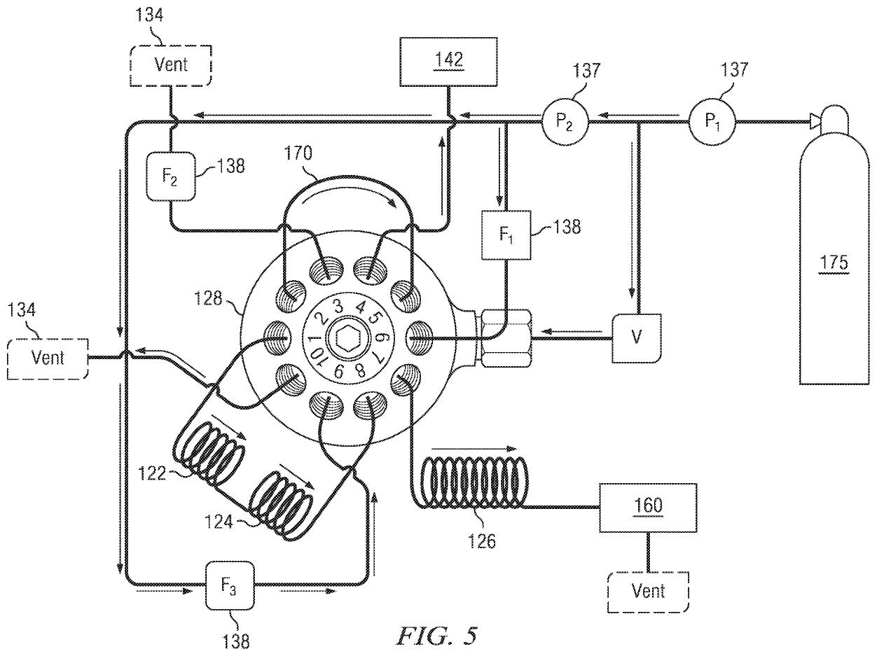

FIG. 5 depicts a schematic of the GC apparatus shown on FIG. 4. As depicted, in this example embodiment, the trapping column 122, the precut column 124, and the main column 126 are in fluid communication with the multiport valve 128. In particular, the trapping column 122 and precut column 124 are coupled in series and are in fluid communication with ports 1 and 8 of the multiport valve 128. The main column 126 is in fluid communication with port 7 and the detector 160. The carrier gas supply 175 is in fluid communication with ports 6 and 9 in this particular embodiment. In alternative embodiments, the carrier gas supply may be fluid communication with port 6 and a separate gas supply may be in fluid communication with port 9. The gas sample injection port 142 is in fluid communication with port 4. A sample collection loop 170 is in fluid communication with ports 2 and 5. Ports 3 and 10 are vented. The example GC apparatus 100 depicted further includes a plurality of pressure regulators 137 and flow regulators 138, as well as vent lines 134.

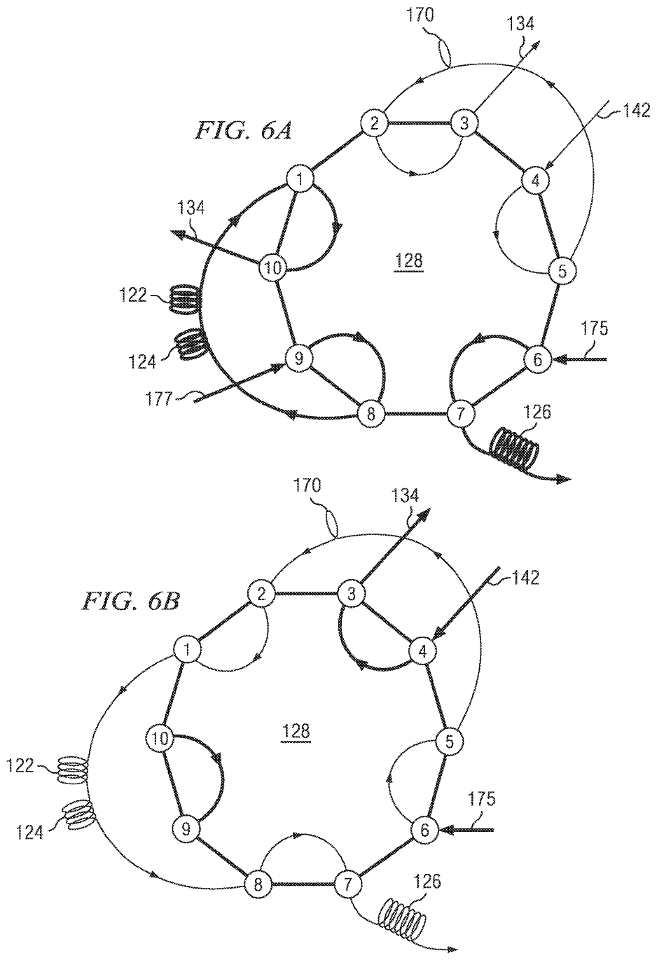

FIGS. 6A and 6B (collectively FIG. 6) depict example flow diagrams for the gas chromatography apparatus shown in FIG. 5 in which the multiport valve 128 is in a first position in FIG. 6A and a second position in FIG. 6B. When the valve is in the first position, port 2 is in fluid communication with port 3, port 4 is in fluid communication with port 5, and so on. When the valve is in the second position, port 1 is in fluid communication with port 2, port 3 is in fluid communication with port 4, and so on. In FIG. 6A, when the multiport valve in the first position, the sample collection loop 170 is filled, the precut column 124 and trapping column 122 are flushed with carrier gas in reverse flow (e.g., to remove heavier hydrocarbons and interfering gases from the columns), and the main column 126 may be flushed with carrier gas. In particular, as depicted, the sample injection port 142 is in fluid communication with the sample collection loop 170 via ports 4 and 5. The trapping column 122 and precut column 124 are in fluid communication with gas supply 177 through ports 9 and 8. Carrier gas flows through the precut column 124 and the trapping column 122 in a reverse direction (to flush the columns) and vents through ports 1 and 10. The carrier gas supply 175 may be coupled to the main column 126 through ports 6 and 7 and vents through the detector (not shown in FIG. 5A).

In FIG. 6B, when the multiport valve 120 is in the second position, the gas sample in the sample loop 170 is transferred through the trapping column 122, the precut column 124, and the main column 126 in the forward direction to the detector. In particular, as depicted, the carrier gas supply 175 is in fluid communication with the sample loop 170 via ports 6 and 5. The gas sample is in turn transferred to the trapping and precut columns via ports 2 and 1 and then to the main column via ports 8 and 7. The sample injection port 142 is vented through ports 4 and 3.

Turning now to FIG. 7, a flow chart of a method 200 for making gas chromatography measurements is depicted. The method 200 includes providing a GC apparatus at 202, for example, including a GC apparatus as described above with respect to FIGS. 3-6. The GC apparatus includes a column assembly including a trapping, precut, and main columns deployed about a mandrel and in fluid communication with a multiport valve. The method further includes setting the valve to a first position at 204, opening a sample injection port at 206 to fill a sample loop with a gas sample when the valve is in the first position, and opening a reverse flow injection port at 208 to flush carrier gas in a reverse direction through the trapping and precut columns when the valve is in the first position. The multiport valve is then set to a second position at 210. A carrier gas port is opened at 212 to transfer the gas sample in the sample loop in a forward direction through the trapping and precut columns and then through the main column to the detector. The gas sample is then evaluated at the detector at 214 to estimate the composition thereof.

With continued reference to FIG. 7, it will be appreciated that method 200 may further include heating the mandrel (to heat the trapping, precut, and main columns), for example, to a temperature in a range from about 40 to about 100 degrees C. while making the GC measurements. In general, the GC measurements may be made at substantially any suitable temperature in the range from about ambient (25 degrees C.) to about 350 degrees C., depending on the characteristics of the analysis column. For mud logging hydrocarbon analysis, as only light alkanes (generally from C1 to C5 or C1 to C8) are quantified, the temperature range may be from about ambient to about 100 degrees C. The method 200 may also further include opening a carrier gas port when the valve is in the first position, e.g., at 206 and/or 208, to flush the main column in the forward direction. Moreover, method 200 may further include repeating 204, 206, 208, 210, 212, and 214 substantially any number of times to make multiple sequential GC measurements, for example, while drilling a well. The repeating may be at substantially any suitable time interval. For example, the valve may be in the first position for about 40 to 50 seconds and in the second position for about 10 to 20 seconds to make GC measurements at approximately 1 minute intervals.

Turning now to FIG. 8, a flow chart of a method 250 for reconditioning (or regenerating) the trapping column in a gas chromatography apparatus is depicted. The method 250 includes providing a GC apparatus at 252, for example, including a GC apparatus as described above with respect to FIGS. 3-6. The GC apparatus includes a column assembly including a trapping, precut, and main columns deployed about a mandrel and in fluid communication with a multiport valve. The method is intended to flush strongly absorbed compounds, such as alcohols, out of the trapping column. The method further includes setting the valve to a first position at 254 and heating the mandrel (and at least the trapping column) to a temperature of at least 120 degrees C. (or at least 150 degrees C.) at 256 (e.g., to a temperature in a range from about 120 to about 200 degrees C. or from about 150 to about 200 degrees C. as hydrocarbons having a boiling point above 150° C. are not generally extracted in relevant quantities from drilling fluid, nor transported without significant condensation to the analyzer, nor analyzed by mud logging gas chromatographs). It will be understood that making precise column temperature measurements can be difficult and that the measured temperature may vary depending on the location along the mandrel at which the temperature measurement is made. A temperature of “about” 200 degrees C. may therefore be understood to be in a range from 195 to 205 degrees C. such that a temperature range from about 150 to about 200 degrees C. may be understood to be a temperature range from 145 to 205 degrees C.

A reverse flow injection port may be opened at 258 when the valve is in the first position and the temperature is above 120 degrees C. (or about 150 degrees C.) to flush carrier gas in a reverse direction through the trapping and precut columns. After some predetermined time (e.g., from about 5 minutes to about 5 hours or from about 1 hour to about 3 hours), the reverse flow injection port may be closed and the heat turned off (or adjusted downward) at 260.

With continued reference to FIG. 8, method 250 may further include using the GC apparatus having the reconditioned trapping column to make a GC measurement. For example, method 250 may further include allowing the mandrel to cool, for example, to ambient temperature or to a temperature in a range from about 40 to about 100 degrees C. and then opening the sample injection port to fill the sample loop. The multiport valve may then be set to the second position and the carrier gas port opened to transfer the gas sample in the sample loop in a forward direction through the trapping and precut columns and then through the main column to the detector where it may be evaluated. Moreover, the GC measurement results may be evaluated to determine whether the reconditioning fully removed the interfering compounds from the trapping column.

It will be appreciated that the column reconditioning in method 250 may be advantageously performed at the rig site without any need to disassemble or disconnect the GC apparatus from the well gas line. Moreover, the reconditioning may be performed at substantially any time interval or whenever it is needed. For example, the reconditioning may be performed when GC measurements (e.g., made using method 200) indicate the presence of interfering compounds in the measurement results. In other example applications, the reconditioning may be performed at some predetermined time intervals, for example, at weekly, monthly, bi-monthly, quarterly, semi-annual, or annual intervals depending on the nature of the drilling operation and the quantity of interfering compounds that are encountered. Moreover, it will be appreciated that the reconditioning may be advantageously performed during rig down times such as when the drill string is being tripped in our out of the well.

In certain example operations it may be advantageous to perform a test to indicate whether or not column reconditioning is needed. For example, a test mixture may be prepared including one or more alcohols, such as an alcohol including from one to five carbon atoms. One example test mixture may include methanol and/or iso-propanol in a nitrogen carrier (e.g., 250 ppm methanol and 250 ppm iso-propanol). The test mixture may be injected with a gas sample and the resultant chromatogram evaluated for alcohol peaks (e.g., a methanol peak in proximity to the iC4 peak and/or an iso-propanol peak in proximity to the iC5 peak). The presence of alcohol peaks may be taken as an indication that column reconditioning is necessary (e.g., when such peaks are at least three times the background noise).

It will be appreciated a decision that reconditioning is necessary may also be triggered by an analysis of field data (e.g., in substantially real time while drilling). When alcohol contaminants are not retained by the trapping column, their peaks would appear on the chromatograms (e.g., close to C4 and C5 peaks). The presence of such peaks may alert an operator (via either manual or automatic detection) that column reconditioning is necessary.

Moreover, it will be further appreciated that the chromatograms may be evaluated for the presence of alcohol peaks after reconditioning. The absence of such alcohol peaks may be taken as indicative of a successful reconditioning operation. Again, such evaluation may be performed manually or automatically.

It will be understood that the present disclosure includes numerous embodiments. These embodiments include, but are not limited to, the following embodiments.

In a first embodiment, a method for reconditioning a gas chromatography apparatus at a rig site includes providing a gas chromatography (GC) apparatus including at least a trapping column, a main column, and a detector, the main column configured to separate at least methane, ethane, propane, butane, and pentane compounds in a gas stream, the trapping column configured to remove interfering alkene or alcohol compounds from the gas stream; using the GC apparatus to make a plurality of GC measurements on the rig site by flowing the gas stream in a forward direction through the trapping column and the main column to the detector; flowing a reconditioning gas in a reverse direction through the trapping column on the rig site after completing the plurality of GC measurements; and heating the trapping column to a temperature above 120 degrees C. while flowing the reconditioning gas in the reverse direction to recondition the trapping column.

A second embodiment may include the first embodiment, wherein the reconditioning gas is a gas comprising argon gas, nitrogen gas, helium gas, air, or a mixture thereof.

A third embodiment may include any one of the first through second embodiments, wherein the trapping column is heated to a temperature in a range from about 150 degrees C. to about 200 degrees C.

A fourth embodiment may include any one of the first through third embodiments, wherein the flowing the reconditioning gas and the heating the trapping column is for at least one hour.

A fifth embodiment may include any one of the first through fourth embodiments, wherein flowing the reconditioning gas in the reverse direction comprises: setting a multiport valve to a first position, the first position providing fluid communication between a reverse flow injection port and the trapping column; and opening the reverse flow injection port to cause the reconditioning gas to flow in the reverse direction through the trapping column.

A sixth embodiment may include the fifth embodiment, further comprising: allowing the trapping column to cool to a temperature below about 100 degrees C.; and closing the reverse flow injection port.

A seventh embodiment may include the sixth embodiment, further comprising: opening a sample injection port thereby enabling a gas sample from the gas stream to flow into a sample collection loop; setting the multiport valve to a second position, the second position providing fluid communication between the sample collection loop and the trapping column; and opening a carrier gas injection port to cause the gas sample to flow in a forward direction through the trapping column and the main column to the detector to make a GC measurement.

An eight embodiment may include the seventh embodiment, further comprising: evaluating the GC measurement for at least one alcohol peak.

A ninth embodiment may include any one of the sixth through eighth embodiments, further comprising using the GC apparatus to make a second plurality of GC measurements on the rig site after flowing the reconditioning gas in the reverse direction through the trapping column.

A tenth embodiment may include the ninth embodiment, wherein the making the second plurality of GC measurements comprises: setting the multiport valve to the first position; opening the reverse flow injection port to cause the reconditioning gas to flow in the reverse direction through the trapping column; opening the sample injection port to cause a gas sample from the gas stream to flow into a sample collection loop; setting the multiport valve to the second position, the second position providing fluid communication between the sample collection loop and the trapping column; opening a carrier gas injection port to cause the gas sample to flow in a forward direction through the trapping column and the main column to the detector; and repeating the setting the multiport valve to the first position, the opening the reverse flow injection port, the opening the sample injection port, the setting the multiport valve to the second position, and the opening a carrier gas injection port to make the second plurality of GC measurements.

In an eleventh embodiment, a gas chromatography (GC) apparatus comprises: a housing; a column assembly including a main column and a trapping column in fluid communication with a multiport valve, the main column configured to separate at least methane, ethane, propane, butane, and pentane compounds in a gas stream, the trapping column configured to remove interfering alkene or alcohol compounds from the gas stream, the column assembly further including a heating element configured to heat the trapping column; a flow manifold in fluid communication with the column assembly, a carrier gas injection port, a reverse flow injection port, and a sample injection port; a GC detector in fluid communication with the flow manifold and the main column; and an electronic controller configured to cause the GC apparatus to make a plurality of GC measurements on the rig site by flowing a gas stream in a forward direction through the trapping column and the main column to the detector, flow a reconditioning gas in a reverse direction through the trapping column after completing the plurality of GC measurements, and heat the trapping column to a temperature above 120 degrees C. while flowing the reconditioning gas in the reverse direction to recondition the trapping column.

A twelfth embodiment may include the eleventh embodiment, wherein the flow manifold comprises a multiport valve.

A thirteenth embodiment may include any one of the eleventh through twelfth embodiments, wherein the electronic controller is configured to flow the reconditioning gas in the reverse direction through the trapping column via setting the multiport valve to a first position in which the first position provides fluid communication between a reverse flow injection port and the trapping column and opening the reverse flow injection port to cause the reconditioning gas to flow in the reverse direction through the trapping column.

A fourteenth embodiment may include any one of the eleventh through thirteenth embodiments, wherein the controller is further configured to allow the trapping column to cool to a temperature below about 100 degrees C., close the reverse flow injection port, open a sample injection port thereby enabling a gas sample from the gas stream to flow into a sample collection loop, set the multiport valve to a second position, the second position providing fluid communication between the sample collection loop and the trapping column, and open a carrier gas injection port to cause the gas sample to flow in a forward direction through the trapping column and the main column to the detector to make another GC measurement.

A fifteenth embodiment may include any one of the eleventh through fourteenth embodiments, further comprising a precut column in series with the trapping column, the precut column configured to remove hydrocarbon compounds having a number of carbon atoms above a threshold.

In a sixteenth embodiment, a method for reconditioning a gas chromatography apparatus at a rig site comprises: providing a gas chromatography (GC) apparatus including a trapping column, a precut column, a main column, a detector, and a multiport valve in fluid communication with the trapping column, the precut column, and the main column, the main column configured to separate at least methane, ethane, propane, butane, and pentane compounds in a gas stream, the precut column configured to remove hydrocarbon compound having a number of carbon atoms above a threshold from the gas stream, and the trapping column configured to remove interfering alkene or alcohol compounds from the gas stream; using the GC apparatus to make a plurality of GC measurements on the rig site by flowing the gas stream in a forward direction through the trapping column and the main column to the detector; setting the multiport valve to a first position after completing the plurality of GC measurements, the first position providing fluid communication between a reverse flow injection port and the trapping column and the precut column; opening the reverse flow injection port to cause a reconditioning gas to flow in a reverse direction through the precut column and the trapping column; and heating the column assembly to a temperature above 120 degrees C. while the reconditioning gas flows in the reverse direction to recondition the trapping column.

A seventeenth embodiment may include the sixteenth embodiment, wherein the trapping column is heated to a temperature in a range from about 150 degrees C. to about 200 degrees C.; and the flowing the reconditioning gas and the heating the trapping column is for at least one hour.

An eighteenth embodiment may include any one of the sixteenth through seventeenth embodiments, further comprising: allowing the trapping column to cool to a temperature below about 100 degrees C.; closing the reverse flow injection port to stop the flow of reconditioning gas; opening a sample injection port thereby enabling a gas sample from the gas stream to flow into a sample collection loop; setting the multiport valve to a second position, the second position providing fluid communication between the sample collection loop and the trapping column; and opening a carrier gas injection port to cause the gas sample to flow in a forward direction through the trapping column and the main column to the detector to make a GC measurement.

A nineteenth embodiment may include the eighteenth embodiment, further comprising evaluating the GC measurement for at least one alcohol peak.

A twentieth embodiment may include any one of the sixteenth through nineteenth embodiments, further comprising further comprising using the GC apparatus to make a second plurality of GC measurements on the rig site after flowing the reconditioning gas in the reverse direction through the trapping column.

Although rig site chromatographic column reconditioning has been described in detail, it should be understood that various changes, substitutions and alternations can be made herein without departing from the spirit and scope of the disclosure as defined by the appended claims.

What is claimed is:

1. A method for reconditioning a gas chromatography apparatus at a rig site, the method comprising:
providing a gas chromatography (GC) apparatus including at least a trapping column, a main column, and a detector, the main column configured to separate at least methane, ethane, propane, butane, and pentane compounds in a gas stream, the trapping column configured to remove interfering alkene or alcohol compounds from the gas stream;
using the GC apparatus to make a plurality of GC measurements on the rig site by flowing the gas stream in a forward direction through the trapping column and the main column to the detector;
flowing a reconditioning gas in a reverse direction through the trapping column on the rig site after completing the plurality of GC measurements; and
heating the trapping column to a temperature above 120 degrees C. while flowing the reconditioning gas in the reverse direction to recondition the trapping column.

2. The method of claim 1, wherein the reconditioning gas is a gas comprising argon gas, nitrogen gas, helium gas, air, or a mixture thereof.

3. The method of claim 1, wherein the trapping column is heated to a temperature in a range from about 150 degrees C. to about 200 degrees C.

4. The method of claim 1, wherein the flowing the reconditioning gas and the heating the trapping column is for at least one hour.

5. The method of claim 1, wherein flowing the reconditioning gas in the reverse direction comprises:
setting a multiport valve to a first position, the first position providing fluid communication between a reverse flow injection port and the trapping column; and
opening the reverse flow injection port to cause the reconditioning gas to flow in the reverse direction through the trapping column.

6. The method of claim 5, further comprising:
allowing the trapping column to cool to a temperature below about 100 degrees C.; and
closing the reverse flow injection port.

7. The method of claim 6, further comprising:
opening a sample injection port thereby enabling a gas sample from the gas stream to flow into a sample collection loop;
setting the multiport valve to a second position, the second position providing fluid communication between the sample collection loop and the trapping column; and
opening a carrier gas injection port to cause the gas sample to flow in a forward direction through the trapping column and the main column to the detector to make a GC measurement.

8. The method of claim 7, further comprising:
evaluating the GC measurement for at least one alcohol peak.

9. The method of claim 6, further comprising using the GC apparatus to make a second plurality of GC measurements on the rig site after flowing the reconditioning gas in the reverse direction through the trapping column.

10. The method of claim 9, wherein the making the second plurality of GC measurements comprises:
setting the multiport valve to the first position;
opening the reverse flow injection port to cause the reconditioning gas to flow in the reverse direction through the trapping column;
opening the sample injection port to cause a gas sample from the gas stream to flow into a sample collection loop;
setting the multiport valve to the second position, the second position providing fluid communication between the sample collection loop and the trapping column;
opening a carrier gas injection port to cause the gas sample to flow in a forward direction through the trapping column and the main column to the detector; and
repeating the setting the multiport valve to the first position, the opening the reverse flow injection port, the opening the sample injection port, the setting the multiport valve to the second position, and the opening a carrier gas injection port to make the second plurality of GC measurements.

11. A gas chromatography (GC) apparatus comprising:
a housing;
a column assembly including a main column and a trapping column in fluid communication with a multiport valve, the main column configured to separate at least methane, ethane, propane, butane, and pentane compounds in a gas stream, the trapping column configured to remove interfering alkene or alcohol compounds from the gas stream, the column assembly further including a heating element configured to heat the trapping column;
a flow manifold in fluid communication with the column assembly, a carrier gas injection port, a reverse flow injection port, and a sample injection port;
a GC detector in fluid communication with the flow manifold and the main column; and
an electronic controller configured to cause the GC apparatus to make a plurality of GC measurements on the rig site by flowing a gas stream in a forward direction through the trapping column and the main column to the detector, flow a reconditioning gas in a reverse direction through the trapping column after completing the plurality of GC measurements, and heat the trapping column to a temperature above 120 degrees C. while flowing the reconditioning gas in the reverse direction to recondition the trapping column.

12. The GC apparatus of claim 11, wherein the flow manifold comprises a multiport valve.

13. The GC apparatus of claim 12, wherein the electronic controller is configured to flow the reconditioning gas in the reverse direction through the trapping column via setting the multiport valve to a first position in which the first position provides fluid communication between a reverse flow injection port and the trapping column and opening the reverse flow injection port to cause the reconditioning gas to flow in the reverse direction through the trapping column.

14. The GC apparatus of claim 13, wherein the controller is further configured to allow the trapping column to cool to a temperature below about 100 degrees C., close the reverse flow injection port, open a sample injection port thereby enabling a gas sample from the gas stream to flow into a sample collection loop, set the multiport valve to a second position, the second position providing fluid communication between the sample collection loop and the trapping column, and open a carrier gas injection port to cause the gas sample to flow in a forward direction through the trapping column and the main column to the detector to make another GC measurement.

15. The GC apparatus of claim 11, further comprising a precut column in series with the trapping column, the precut column configured to remove hydrocarbon compounds having a number of carbon atoms above a threshold.

16. A method for reconditioning a gas chromatography apparatus at a rig site, the method comprising:
providing a gas chromatography (GC) apparatus including a trapping column, a precut column, a main column, a detector, and a multiport valve in fluid communication with the trapping column, the precut column, and the main column, the main column configured to separate at least methane, ethane, propane, butane, and pentane compounds in a gas stream, the precut column configured to remove hydrocarbon compound having a number of carbon atoms above a threshold from the gas stream, and the trapping column configured to remove interfering alkene or alcohol compounds from the gas stream;
using the GC apparatus to make a plurality of GC measurements on the rig site by flowing the gas stream in a forward direction through the trapping column and the main column to the detector;
setting the multiport valve to a first position after completing the plurality of GC measurements, the first position providing fluid communication between a reverse flow injection port and the trapping column and the precut column;
opening the reverse flow injection port to cause a reconditioning gas to flow in a reverse direction through the precut column and the trapping column; and
heating the column assembly to a temperature above 120 degrees C. while the reconditioning gas flows in the reverse direction to recondition the trapping column.

17. The method of claim 16, wherein:
the trapping column is heated to a temperature in a range from about 150 degrees C. to about 200 degrees C.; and
the flowing the reconditioning gas and the heating the trapping column is for at least one hour.

18. The method of claim 16, further comprising:
allowing the trapping column to cool to a temperature below about 100 degrees C.;
closing the reverse flow injection port to stop the flow of reconditioning gas;
opening a sample injection port thereby enabling a gas sample from the gas stream to flow into a sample collection loop;
setting the multiport valve to a second position, the second position providing fluid communication between the sample collection loop and the trapping column; and
opening a carrier gas injection port to cause the gas sample to flow in a forward direction through the trapping column and the main column to the detector to make a GC measurement.

19. The method of claim 18, further comprising:
evaluating the GC measurement for at least one alcohol peak.

20. The method of claim 16, further comprising further comprising using the GC apparatus to make a second plurality of GC measurements on the rig site after flowing the reconditioning gas in the reverse direction through the trapping column.
